(19) United States
(12) Patent Application Publication
(10) Pub. No.: US 2003/0233341 A1
(43) Pub. Date: Dec. 18, 2003

(54) Systems and methods for work list prediction

(76) Inventors: Amanda Kim Taylor, Shenington (GB); Nicholas Paul Haines, Swindon (GB); Justin Christopher Brunt, Swindon (GB)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/429,494

(22) Filed: May 5, 2003

Related U.S. Application Data
(60) Provisional application No. 60/384,014, filed on May 29, 2002.

(51) Int. Cl. G06F 7/00

(52) U.S. Cl. 707/1

(57) ABSTRACT

The present invention is related to systems and methods that predict work lists. One embodiment of such a method includes: (a) receiving information regarding a workflow process of interest; (b) receiving a process definition for the workflow process; (c) based on the process definition, determining at least one outstanding step for a case of the workflow process; (d) receiving a definition for the outstanding step; (e) executing the outstanding step to calculate an expected end time for the outstanding step; and using steps (a) to (e), predicting work items that are expected to become in association with the work flow process of interest. The definition for the outstanding step can include a predicted condition. Executing the outstanding step can include evaluating the condition based at least in part on the process definition and on case data.

### CROSS-REFERENCES TO RELATED APPLICATIONS

This patent application claims the benefit of U.S. Provisional Patent Application Serial No. 60/384,014, filed May 29, 2002, the entirety of which is incorporated herein by reference.

### BACKGROUND OF THE INVENTION

The present invention relates to workflow management and, more particularly, to systems and methods for predicting work lists associated with a workflow.

A workflow typically includes a number of distinct steps. For example, the workflow for processing an application, e.g., an insurance application, might include: 1) capturing application details; 2) allocating the completed application to a processor; 3) processing the completed application; and 4) archiving the completed application. A case is an instance of a workflow.

Systems for managing workflow currently exist. For example, U.S. Pat. No. 5,918,226 issued to Tarumi et al, entitled “Workflow System for Operating and Managing Jobs with Predicting Future Progress of Workflow Job,” relates to, among other things, predicting whether a particular case of a workflow can meet a predefined deadline.

U.S. Pat. No. 6,115,640 issued to Tarumi, entitled “Workflow system for rearrangement of a workflow according to the progress of a work and its workflow management method,” also relates to, among other things, predicting whether a particular case of a workflow can meet a predefined deadline.

However, a need remains for systems and methods that: list future tasks with their expected start times and durations; list future tasks for a case of a workflow; list future tasks for a particular worker or group of workers; and/or list future tasks that relate to a particular item of data, e.g., a patient identification number. Furthermore, a need exists for systems and methods that allow a workflow designer to include conditionals in the prediction of a work list.

### SUMMARY OF THE INVENTION

The present invention is related to systems and methods that predict work lists. In one embodiment, the work lists provided include not only the work items currently due, but also the work items that the system expects to become due in the future.

One embodiment of the invention predicts future work steps for a single case of a workflow. When the system receives the name of a workflow, it predicts future work steps for the named workflow. Embodiments of the invention can predict against a live case of the named workflow or can simulate a hypothetical case of that workflow. In both cases, embodiments of the invention retrieve the definition of the workflow in question (the definition of the workflow steps and the routing logic between those steps).

When the system operates on a live case, the system retrieves the case's data. The system then interrogates the workflow to retrieve one or more outstanding steps for that case. Using these outstanding steps, prediction logic executes (simulates the execution of) the outstanding steps to determine the expected duration of the steps and determines from the process definition the steps that will succeed the current outstanding steps. A succeeding step may include a conditional action. The prediction logic executes the conditional action to determine the route to be taken through the process on completion of the step prior to the step that includes the conditional action.

Using the mechanism described above, a system, according to one embodiment of the invention, creates a list of future steps and their expected start times and durations.

When the system operates on a hypothetical case of the workflow (a simulation), the system receives simulated data as well as the step at which to start the prediction. Apart from this difference in the data received, all other actions are the same as for a live case.

Another embodiment of the invention predicts lists of future work steps that satisfy particular query criteria for one or more live cases of one or more workflow processes.

In this embodiment, when an entity, e.g., a worker, performs an action on a case of a workflow, the performance of the action triggers a prediction module. The prediction module receives an identifier for the case and the workflow concerned. The prediction module retrieves the workflow definition and the case specific data. The prediction module then generates the future work list as described above. In one embodiment the future work list updates a master list that contains future work lists for all live cases of workflows. When the newly generated future work list for a case updates the master future work list, the newly generated future work list replaces any previous future work list for the case in question.

The system can then query the master list to find future work lists according to a variety of criteria such as worker identification, case number/subject identification, and time period of interest.

Another embodiment of the invention provides a method for predicting a work list. The method includes: (a) receiving information regarding a workflow process of interest; (b) receiving a process definition for the specified process; (c) based on the process definition, determining at least one outstanding step for a case of the workflow process; (d) receiving a definition for the outstanding step; (e) executing the outstanding step to calculate an expected end time for the outstanding step; and using steps (a) to (e), predicting work items that are expected to become due in association with the workflow process of interest. The definition for the outstanding step can include a predicted condition. Executing the outstanding step can include evaluating the condition based at least in part on the process definition and on case data.

Still another embodiment of the invention provides a work list prediction system for predicting a work list for at least one specified workflow process. The system includes: a process definition receiving module operative to receive a process definition for a specified process. The system also includes a step determining module in communication with the process definition receiving module. The step determining module determines at least one outstanding step for a case based on the process definition. The system includes a step definition receiving module in communication with the step determining module. The step definition receiving module receives a definition for the outstanding step. The system also includes an execution module in communication with the step definition receiving module. The execution module executes the outstanding step to calculate an expected end time for the outstanding step.

### BRIEF DESCRIPTION OF THE DRAWINGS

One can understand the present invention more fully from the detailed description below and from the accompanying drawings of embodiments of the invention. The drawings are for illustration only and should not limit the scope of the invention.

FIG. 1 shows one version of software architecture for a process management system.

FIG. 1B shows a screen shot of a process definer for use with the system of FIG. 1.

FIG. 1C shows buttons that are included in the toolbar of the process definer of FIG. 1B.

FIG. 2 is a block diagram of a work list prediction module according to the present invention, which, in one embodiment, can be used in the architecture of FIG. 1.

FIG. 3 is a flow chart illustrating one embodiment of a method according to the present invention, the method being capable of being performed by the work list prediction module of FIG. 2.

FIG. 4 is a diagram showing an example of a process definition for a process including only the outstanding steps remaining in the process for a given case.

FIG. 5 shows a Process status dialogue box that allows a user to interact with the system of FIG. 1.

FIG. 6 shows a step definition dialogue box that allows a user to interact with the system of FIG. 1.

FIG. 7 shows a step duration dialogue box accessible from the step definition dialogue box of FIG. 6 and shown with the step duration period radio button selected.

FIG. 8 shows a step duration dialogue box accessible from the step definition dialogue box of FIG. 6 and shown with the expression radio button selected.

FIG. 9 a step deadline dialogue box that allows a user to interact with the system of FIG. 1.

FIG. 10 shows a condition definition dialogue box.

FIG. 11 is a block diagram showing a computer system for implementing one embodiment of the present invention.

FIG. 12 is a block diagram illustrating the generation of a work list by the prediction module of FIG. 2.

### DETAILED DESCRIPTION OF THE ILLUSTRATED EMBODIMENTS

The present invention relates to systems and methods that predict work lists, e.g., lists of work items to be completed. The work items can be part of one or more workflows. A workflow typically includes a number of distinct steps. Each step can include one or more work items.

In one embodiment, the work lists include both the work items currently due and the work items that are expected to become due in the future. Examples are a list of all work expected to be performed for a particular patient during his expected stay at the hospital (could be many days), and a list of all the work to be performed during the current shift (8-12 hours) by nurses for the patients for which they are responsible. Other examples include a list of all work expected to be performed by a particular insurance application processor during the current month and a list of all the work to be performed during the current month by insurance agents under the supervision of a particular manager.

Having the ability to perform the above provides a user with the ability to improve their work forecasting to determine what work is outstanding and also to help a manager determine when to expect work to be completed in the future. A manager or supervisor can use this functionality to help resource expected work more reliably. Customer service personnel are able to respond to an enquiry about the expected occurrence of an action on a case more reliably.

A workflow management system manages at least one workflow. The terms workflow, workflow process, and process are interchangeable for present purposes. As noted above, a workflow typically includes a number of distinct steps. Each workflow is associated with data and links to other systems in a database. A case refers to an instance of a workflow. Workers/participants perform steps or parts of steps that are make up a case. In one embodiment, workers/participants receive their cases via a workqueue. Workflow process designers first specify the steps of a workflow and then, for each step, determine the purpose of the step, define its associated data requirements and user involvement. Thus, a number of steps with defined relationships can make up a workflow.

Using test data and providing a list of start steps, instead of live data and real outstanding steps means that one can use the prediction functionality of the present invention for case simulation.

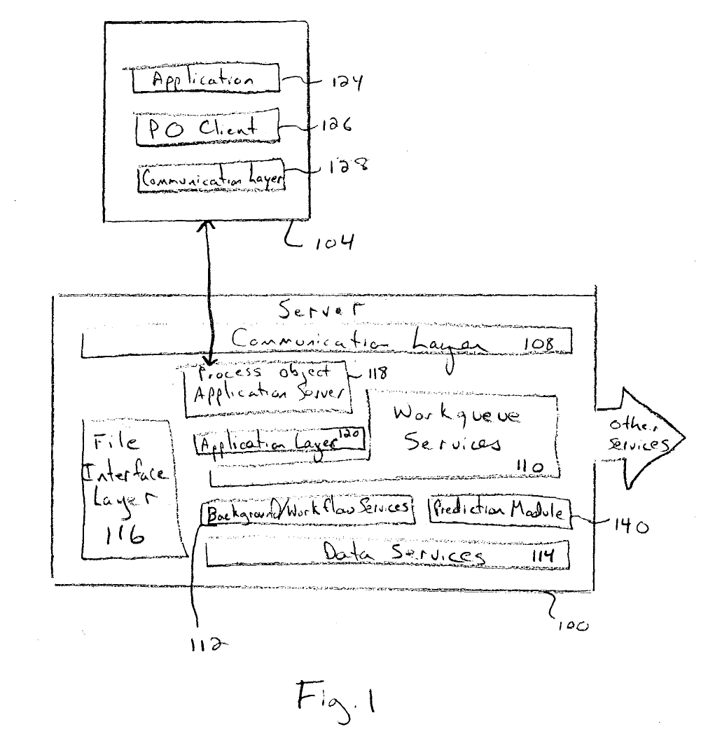

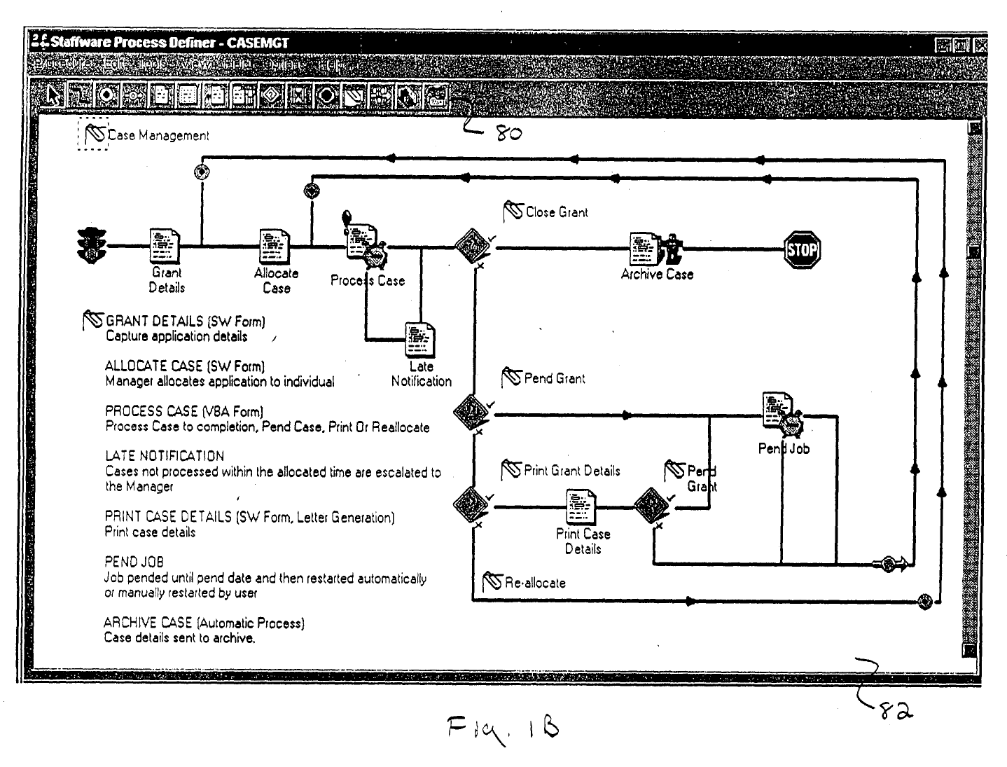

One can use the systems and methods of one embodiment of the present invention with a workflow management system. With reference to FIG. 1, software architecture for a workflow management system 100 can adopt a layered structure including a communication layer 108, workqueue services 110, background/workflow services 112, data services 114, a file interface layer 116, an application server 118, an application layer 120, and a prediction module 140. Also shown in FIG. 1 is Process Objects client (104) adapted for interacting with workflow management system 100 also referred to as the process engine.

Client services include workqueue services 110, application server 118, and application layer 120. Workflow Services include background/workflow services 112 and prediction module 140. Both Client Services and Workflow Services access the Data Services (114) through the File Interface Layer (116).

Process Objects “Clients” 104

The Process Objects (PO) Client 104 includes an application 124, a process object client component 126 and a communication layer 128. A developer creates application 124 using the interfaces exposed by the Process Object Client component 126. The application can either be a user facing application, i.e. one that includes a user interface, or one that interfaces directly to another application. The workflow management system provides a number of such applications such as a Process Definer (used for defining a process). In all cases, applications are able to examine process information or open work items from work queues and manage the work items. In many cases, customers of the workflow management system create their own applications using the functionality provided by the Process Objects Client 126.

The PO Client 126 exposes a programming interface to allow customers of the workflow management system to build workflow applications. The PO Client exposes workflow functionality and data to allow an application to access workflow process, work items, workflow relevant data, and organizational and administrative information/functionality. The workflow management system also provides applications that are built on the PO Objects interface. The PO Client provides the data and functionality through access to the corresponding server based components on the Process Objects Application Server 118 via the communications layers 128 and 108.

The client side communication layer 128 communicates with the server side communication layer 108 to facilitate the exchange of workflow relevant data and functionality bi-directionally between the PO Client 126 and the PO Application Server 118.

The Process Objects “client” provides application developers with an object-oriented interface that reduces the amount of effort and time required to develop enterprise wide workflow applications. By implementing the Process Objects “client” with industry standard interfaces, developers can use development tools of their choice to interface with a customer's business solutions. The Process Objects client provides application developers with access to the management functionality of the customer's systems. TCP/IP facilitates communication with the server. The PO clients interface with the workflow management system 100 via the PO application server 118.

Process Objects clients are available for both Windows 32 bit platforms (Windows 98/Me, Windows NT and Windows 2000) as well as a Web Client (a thin browser-based client). The Web Client is available for use with Microsoft and UNIX based Web Servers using Active Server Page (ASP) and Java Server Page (JSP) technologies, respectively. The Web Client is one embodiment of application 124. However, one can use other applications 124 to interface with system 100.

For the Windows 32 bit based variant, developers have access to the Application Layer (AL) programming interface which allows a developer to customize the user interface provided by application 124. For example, a developer can use an alternative forms package instead of standard forms facilities.

For the Windows 32 bit variants, TCP/IP facilitates communication between the Process Objects Client 104 and the Process Engine 100 while the Web Client uses the standard HTTP options (including SHTTP) for communication between the browser and web server.

File Interface Layer (FIL) 116

The File Interface Layer (FIL) 116 is a module that provides all other components, including the clients, with access to data that either resides in the host file system or in a relational database management system (RDBMS). In the case where the data is held in an RDBMS, the physical access to the data is performed by the Database Services components but is controlled by the FIL. The FIL performs its functions such that it is transparent to other components as to whether the data is held in files on the host file system or in a RDBMS.

Process Objects Application Server 118

The Process Objects Application (POA) Server 118 is a gateway service between the Process Objects client 104 and the Process Engine 100. The POA server 118 is responsible for managing the connections between the Process Engine and Process Objects based applications and provides the clients with the workflow functionality they request. The POA Server 118 is a multi-threaded component designed for high performance and scalability. Direct sockets facilitate communication between the Process Objects client and the server 100 over TCP/IP.

Web Client Gateway

Web Clients communicate with a Web Client Gateway that resides on the Web Server. The Web Client Gateway is an application that is built on top of the Process Objects Client (126). Indeed it is an example of an Application (124). It runs in a Web Server environment and is exposed to Web Browsers though hypertext links on Web Pages. When activated though web page access it is able to provide workflow relevant data, presentation and functionality to the web browsers as well as communication back to the workflow server (100) via the communication layers (108 and 128). The Web Client Gateway uses Process Objects to provide stateless Workflow functionality for the Web Clients and communicates with the POA Server 118 using TCP/IP and hence may reside on a separate machine.

Application Layer (AL) 120

The Application Layer (AL) 120 provides client based Workflow functionality for the different client based services (Client User Interface and Process Objects application server 118). The services provided by the AL range from log in/log out, Open Work Item to Release Work Item. Open Work Item and Release Work Item are services used in interacting with specific work items being managed by a workflow management system. The AL 120 also provides access to process definitions described further below.

Work Queue Services 110

The Work Queue Services 110 provide the following services:

Supplies users with information about which queues they have access to and how much work is in them.

Supplies users with information about which items appear in the Work Queues.

Provides interfaces for Searching/Sorting/Filtering the items in the queues.

The Work Queue Services 110 facilitate the ability to scale a workflow management system incorporating the architecture of FIG. 1. The Work Queue Services 110 employ multi-processing and multi-threading technologies to improve utilization of the hardware and operating systems facilities available.

The Work Queue Services include two component types: a) A Work Queue Server (WQS) which provides information about who has access to various queues; and b) A Work Item Server (WIS) which provides information about the contents of the work queues (i.e., about the work items residing in the work queues).

One embodiment incorporates a single WQS process but a configurable number of WIS processes. At system start up, the configured number of WIS processes share the work queues to provide load balancing. The configured number of WIS processes share on a Round Robin basis or by allocating the most heavily loaded queues to different WISs (where possible).

In a typical workflow management system, the number of work queues exceeds the number of WIS processes that have been configured. As a consequence, each WIS process needs to manage a number of work queues. To ensure that each WIS process does not handle the operations serially, which would cause delays in the operations requested by client applications, the WIS processes are multi-threaded. Each WIS process has a pool of threads of execution. When a request is made to a WIS process either by the Workflow services or by a client application, the WIS process allocates the request to a thread. Thus, each WIS can service multiple service requests in parallel. In the same way that the WIS processes must manage multiple queues the WQS process must be able to service all of the WIS processes. For that reason the WQS employs multi-threaded technology to allow it to service multiple service requests from WIS processes in parallel.

Employing these technologies results in the ability to support many thousands of clients concurrently. An individual server may be responsible for multiple clients running concurrently. Such a server can use multi-processing and multi-threading technologies to serve its clients concurrently.

In addition, the methods employed to provide work items to clients means that client-server latency is kept to a minimum and network bandwidth utilization is economic.

The Work Queue Services 110 supply lists of work items to clients in fragments. The Work Queue Services transmit fragments to the clients on demand rather than transmitting a complete work queue. In a user interface situation where a user is scrolling through a work queue to select work items, only sufficient work items are downloaded in a single operation to populate a screen. Because the Work Queue Services work at the pace of the client they are able to supply work items with minimal latency and are able to serve a huge user population without undue strain on the network infrastructure.

Workflow Services 112

The Workflow Services component 112 is responsible for the interpretation of business rules that a process designer has defined using a Process Definer (an example of an application 124) and for turning the business rules into an automated process. The Workflow Services receive requests via the various layers of the architecture from the applications 124 in Process Objects Clients 104 to perform actions such as: Start a Case of a Specified Workflow Process or Completion (Release) of a Specific Step of an instance (Case). The Workflow Services component 112 examines the process definition and determines what needs to happen next. For example, the Workflow Services component might update data that has been modified as part of the previous step that was released/completed and then send out a new work item to a work queue.

As noted above, the process definer is an application 124 in a Process Objects client 104. The user of the process definer creates a new process or opens an existing one for modification and edits it using user interface facilities. The process engine 100 stores the process definition in the process engine's database and accesses the process definition through the File Interface Layer (FIL) 116.

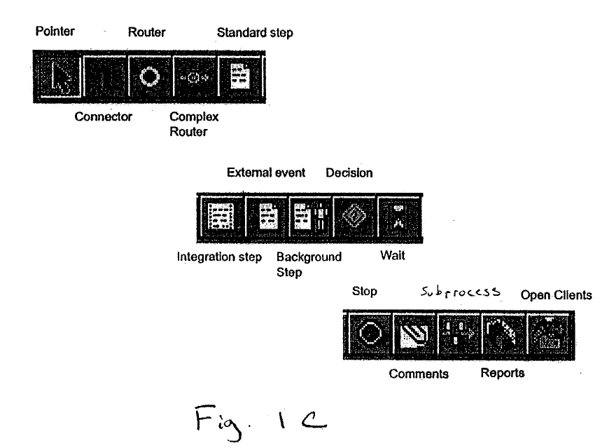

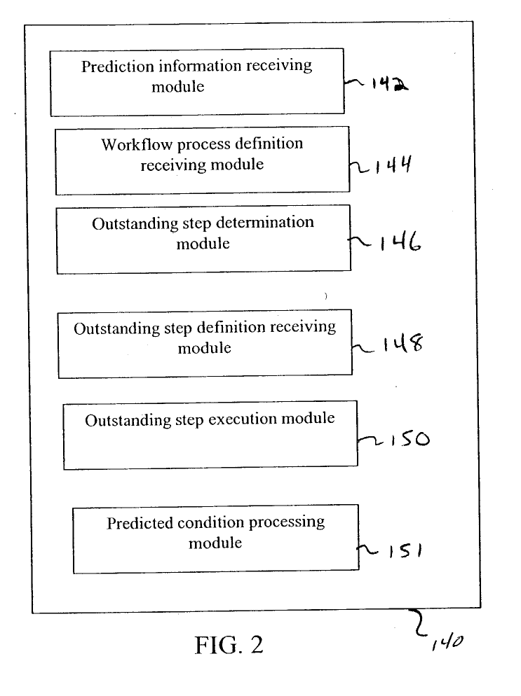

The prediction module 140 accesses a Process Definition by sending a request to the FIL 116. The prediction module 140 is described further below with reference to FIG. 2.

For each step (activity) in a workflow process there is/are one or more action(s) (i.e., what happens next). The action may be as simple as when step A has completed go to Step B. However, the action can include a condition such as:

If loan-amount >$10000 go to step B otherwise go to step C.

When an action includes a condition, the workflow services component reads the process definition to find out what the action(s) is/are for the current step and evaluates the condition associated with the action(s). There is an expression evaluator that knows about all the possible types of expressions that are supported by the particular embodiment of the invention. An expression is an equation with one or more variables. Value(s) can be inserted into the expression for the variable(s) to evaluate whether the expression is true given the value of the variable(s). The expression evaluator obtains the appropriate pieces of information. In the given example, the expression evaluator determines: the value of the loan-amount from the workflow relevant data; what the operator is (>in this case); and what the expression evaluator needs to compare the loan-amount against ($ 10,000). The expression evaluates to either a TRUE or FALSE value, which is then returned to the main body of the workflow services module. The main body then can determine which route to go down and hence which action to take (step B or step C).

The Workflow services component routes Work Items or tasks to the workers/participants work queues or to external applications. The Workflow Services component receives the completed work items from the users work queues or external application and makes decisions based on the data and process definition to determine where to route the next work item in the workflow. In other words, the workflow services component 112 receives data obtained via a step in a process and updates the database associated with the process. The workflow services component 112 then obtains a process definition and updated case data and applies the updated case data to the process definition to determine the next step in that case of the process.

Database Layer Services 114

In the case where data is stored in a RDBMS, the Database Services component 114 provides the FIL 116 with access to the data.

Process Definer

With reference to FIGS. 1B and 1C, one embodiment of a process definer (PD) 82 includes a tool bar 80 for defining a process. Using drag and drop functionality, one can define a process by selecting appropriate elements form the toolbar 82 and dragging the selected elements to the pallet below. The toolbar includes the following selections: pointer, connector, router, complex router, standard step, integration step, external event, background step, decision, wait, stop, comments, subprocess, reports, and open clients. The following provides a description of these selections. In the illustrated embodiment, there are four types of steps definable in a process and they are:

1. Normal/Standard Steps—This type of step is oriented toward end user interaction and has associated with it a method of interacting with the user. One can achieve this type of step in a variety of ways, either by using forms defined using the Step Definer or via a commercial product such as Microsoft Visual Basic, PowerSoft PowerBuilder, C and C++, and many others. As normal steps have this accent on end user interaction, they naturally appear in the users' work queue. However, a normal step need not always have a form associated with it and can be used formless for the purpose of user notification.

2. Integration Steps—This type of step is used as a means of automating some of the activities related to a given step. Automatic steps are used to invoke external applications that run without user intervention. For example, integration steps may be used to exchange information with a database, print a standard letter or invoke Imaging or Document Management software. By their nature, integration steps do not appear in user's work queues.

3. Event Steps—These are steps that stop the flow of a process until some special conditions—possibly external to the process—have occurred. Event steps may therefore be used to synchronize a step in a Workflow with some external event. Event steps may be used to pause or suspend a case, manage process exceptions or change step data. Event steps may also be used to synchronize otherwise independent Workflows.

4. Open Client Steps are used to facilitate the integration of embodiments of the invention with desktop applications such as Microsoft Exchange and Lotus Notes. The Open Client Step is a combination of the Integration Step and an Event. When using an Open Client Step, embodiments of the invention do not send out work items but instead call applications with parameters. The workflow is suspended until the user application tells it to continue. In other words, the system suspends the execution of that instance/case of the workflow process until the external application provides a response. The whole system is not suspended as the workflow services can continue processing other instances of either the same or different workflow processes.

Sub-Processes

Embodiments of the invention enable developers to select sub-processes from a toolbox, drag them onto the PD pallet and add them to existing, or new, processes.

When a user wants to add a sub process, he or she selects the component tool from the PD tool bar. The user drags the selected tool onto the pallet and drops it into the required place in the process—the same method used to add a normal step.

Once dropped, the PC requests that the user specify the name of the sub process. The user can also specify at which step of the sub-process the controlling process enters the sub-process. Existing processes are linked into the controlling process and accessible by double clicking the icon. The controlling process has all the attributes of the new process added to it (fields, actions, Step Definitions/Forms etc.). As noted above, an action is an event in a workflow process. In other words, an action is an act, either an automatic act or an act requiring user interaction or external application input that is assigned to a step by the step definer.

In one embodiment, the full process, including sub-processes has a single, consolidated audit trail. The audit trail is a record of the actions that were performed on a case of a workflow. It will include events such as:

Case Started

Step A sent to user X

Step A released by user X

Case Completed

Case Terminated

Event Triggered

Case Suspended

Case Reactivated

In one embodiment all activities are given a time stamp. The audit trail serves at least two purposes: i) the audit trail aids in debugging a process; and ii) the audit trail provides evidence that activities actually took place.

The benefits of the sub-process functionality are:

Reusability—a number of steps and associated process logic can be encapsulated into a sub-process which can then can be re-used either within the same process or across a number of processes.

Process modularity—in a complex process there can be a large number of steps. Where such processes are implemented as a single process this can present various difficulties including: understanding the whole process, and maintenance of and enhancements to the process. Breaking a process down into a number of logical blocks and encapsulating each of those blocks within a sub-process such that a master process controls the overall flow helps to alleviate these difficulties.

Multi-user development—in cases where one can break a process down into a number of logical blocks, different process definers can implement and maintain each of the blocks.

Other Step Options

There are other mechanisms used in conjunction with process steps that further enhance the richness of a process definition. They are:

Deadlines—These are a design construct for time-based alerting. Deadlines are associated with steps, but are an attribute of a step rather than a different type of step. According to embodiments of the invention, one can define a deadline using either a Period or Expression. A Period Deadline statically defines a period of time that must elapse before the system invokes the Deadline action. Embodiments of the present invention measure this period of time from the point in time when the work item first appeared in the user's work queue. Embodiments of the invention use an Expression Deadline on the other hand to dynamically define a Deadline at runtime. There are a variety of date and time functions available that embodiments of the invention can apply to case data to establish an appropriate deadline period. Once a deadline expires, embodiments of the invention may initiate another sequence of steps, and can optionally remove the Step from the user's Work Queue. The latter method is known as a Step Withdraw Action. In other words, a Withdraw Action removes a Step from a user/worker's Work Queue once the deadline for performance of that Step expires.

Routing, Branching, Conditions and Parallelism—These design constructs are used to manage the routing logic of the Workflow. The routing logic enables devolved control as the process path may be dynamically altered by the prevailing condition of the case data. In other words, because there are conditions that can be evaluated using case data, it is possible that two different cases (instances) of the same workflow process may actually take different routes. Similarly the addressee (worker) assigned to a particular activity may be decided at run time. Therefore, both paths and workers may differ from one case to another. However, the layout of the process is fixed at design time.

Dynamic alteration of the process path as a result of the prevailing condition of the case data means that processes can react effectively to events after the process has started. One can construct parallel branches composed of differing Steps. For example, a case may be routed down parallel branches where presentation of information to the user and process behaviour may be quite different depending on the definitions in each branch. In the case of an (OR) split, a case progresses down either one route or another. In the case of an (AND) split, a case progresses down both paths in parallel. The actions/steps/presentation may be very different for each path.

Complex router—This is a type of step that is in effect a null action and that has minimal server overhead. When the background process processes a Complex Router, the Complex Router's actions are immediately processed and the step is not actually sent out to any queue.

Complex Routers are Useful in the Following Scenarios:

Collection points for complex actions—If there are several steps that have the same set of complex actions then these actions can be assigned to a Complex Router which will be processed when the other steps want their common complex actions processed.

Clarity of PD—The layout of the process in the PD can be enhanced with the use of Complex Routers to remove duplication in the links between steps.

Waits—These are a special type of routing construct and again are not strictly a type of step. Waits embody a point of synchronization for multiple parallel routes in the Workflow. A Wait routing construct is a way to join two paths, e.g., two AND paths described above, back together. Indeed, a Wait is sometimes referred to as an AND Join. The combination of Parallelism, Waits and Events presents the Process Definer with a mechanism for defining real world scenarios. For example, it is possible to implement a Workflow scenario where incomplete branches are correspondingly terminated using the Withdraw action. Thus, using the process definer, a process designer can create relationships between steps and can also define the steps involved.

Expanding on the example of a process shown in FIG. 1B, the process handles an application for a grant. The grant step obtains information from an applicant such as the purpose of the grant and applicant background information. The process proceeds to an allocate step where a manager allocates the case to an appropriate processor/worker. The process proceeds to a process step where a processor decides whether to approve the grant. If the processor does not approve or reject the case by a specified time, the defined process notifies the manager. Following processing, a number of conditions or decisions follow. A first decision determines whether to close or archive the case and stop. If the processor does not archive the case, a next decision is whether to pend the application. If the case takes the pend route, the defined process recycles the case to the process case stage. If the case does not take the pend route, the next decision is whether to print the grant details and whether to pend the application. Again, if the print case route is taken, the defined process recycles the case to the process case stage. If the print grant route is not taken, then the defined process re-allocates the case to a different processor, i.e., the manager selects another worker to process the application.

Given a description of how a designer determines the structure for a process and the definitions for the steps that make up the process, with reference to FIG. 2, a system 140 for predicting work lists according to one embodiment of the invention includes a prediction information receiving module 142. The prediction information receiving module receives information relating to a workflow of interest, e.g., the name of a process to call and a case reference number. The system includes a process definition receiving module 144 in communication with the prediction information receiving module. The process definition receiving module receives a process definition for a specified workflow process. The system includes a step determining module 146 in communication with the process definition receiving module. The step determining module 146 determines at least one outstanding step for a case based on the process definition. The system includes a step definition receiving module 148 in communication with the step determining module. The step definition receiving module 148 receives a definition for the outstanding step. The system also includes an execution module 150 in communication with the step definition receiving module 148. The execution module 150 executes the outstanding step to calculate an expected end time for the outstanding step. The system can further include a predicted condition processing module 151 in communication with the execution module 150. The predicted condition processing module 151 processes a condition that is part of an outstanding step.

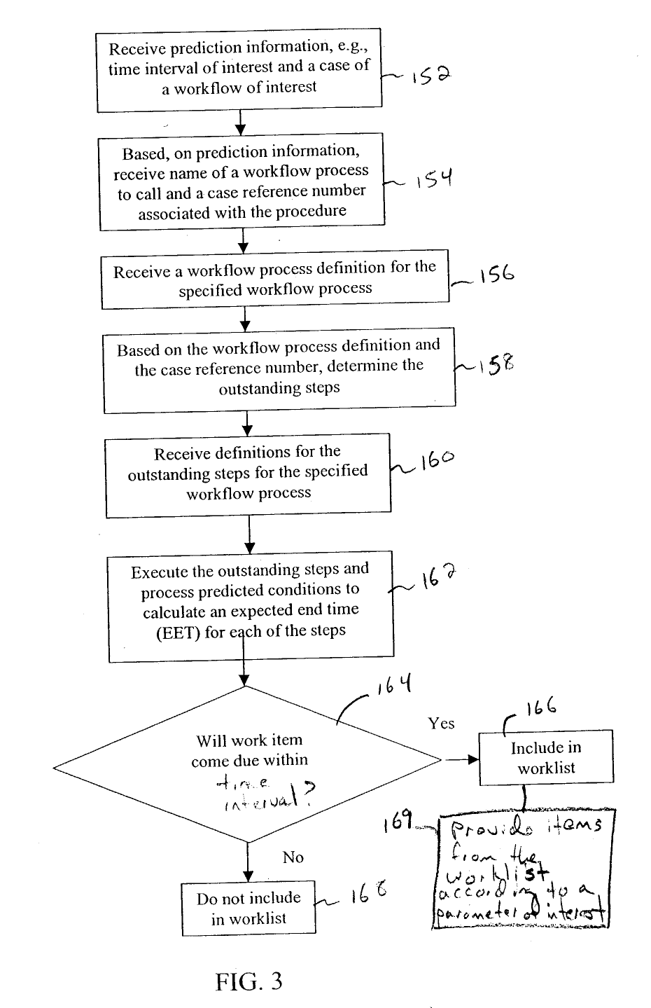

In operation, with reference to FIG. 3, a system according to one embodiment of the invention receives 152 prediction information, e.g., a time interval of interest and a case of interest. Based on the prediction information, the system receives 154 the name of a process to call and a case reference number associated with the process. The system then receives 156 a process definition for the specified process. Based on the process definition and the case reference number, the system determines 158 the outstanding steps. The system then receives 160 definitions for the outstanding steps for the specified process and the system simulates 162 the execution of the outstanding steps and manages predicted conditions to calculate an expected end time (EET) for each of the steps. If a work item comes due within the time interval, the system includes 166 the item in the work list. If not, the system does not include 168 the item in the work list. The system can then provide 169 items from the worklist according to one or more parameters of interest.

The system can call the prediction function, i.e., the prediction module, directly to obtain a prediction for a specified case. The system stores the results produced by the prediction module 140, shown in FIG. 2, in a list and can retrieve the list through another prediction function call. Alternatively, the prediction module can run continuously in the background to re-predict each case whenever the background performs any action on a case. The system stores the results of running prediction in a data store that the system can then query.

The prediction process, from whichever route it is called, moves through the designated process step by step using live or simulated case data to decide which route to take where there is a conditional action. Each step has an expected duration that the prediction module uses to calculate an end processing time for the current step and the start processing time of the next step(s). Once a step has been processed, the system stores all key information for retrieval. For a direct call, this retrieval is from a list. To access the data generated by the continuously running prediction from the data store the retrieval is via a query and embodiments of the invention provide a query interface for this purpose.

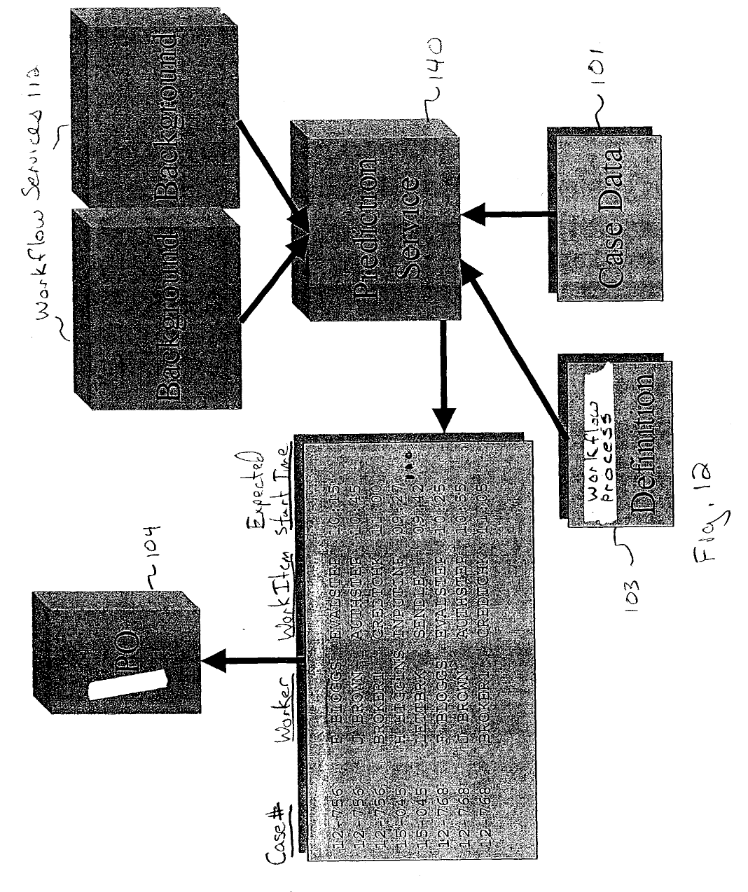

Thus, in one embodiment, with reference to FIG. 12, as workflow services/background services 112 complete each step, these services trigger prediction service 140 to recalculate based on data that has been updated by the workflow services 112. The prediction service 140 obtains the relevant process definition 103 and the relevant and updated case data 101 and generates a work list, which is then sent to the relevant process object 104. The work list shown includes fields for the case number, the worker, the work item and the expected start time. These fields are for illustration only and are not meant to be limiting. Other fields such as expected end time could be included.

Case Change Notification

When a background process (BG) 112 processes an instruction that results in a change to a case, the BG notifies the predict services/module 140 in order that the prediction data, held in the database, can be updated to reflect the latest data.

In one embodiment, a BG makes a change to a case when processing the following instructions:

NEWCASE

This instruction is sent to the BG in order that a new case of a workflow process can be started.

RELEASE

This instruction is sent to the BG when a client has released an outstanding step.

FORWARD

This instruction is sent to the BG when a client has forwarded a step from one queue to another.

EVENT

This instruction is sent to the BG when an “event” has been issued on a case of a workflow process. This instruction can be used to update case data for a case or to resurrect a dead case.

CLOSE

This instruction is sent to the BG when a case is to be closed i.e. it will become a dead case. The case data and audit trail information are still present on the system and the case can be resurrected by using the “event” instruction.

PURGE

This instruction is sent to the BG when a case is to be purged. This instruction removes all case data and audit trail information from the system, which means that the case cannot be resurrected.

If a workflow process is flagged for prediction a BG process en-queues a message to a predict queue indicating the case that has changed and indicating the workflow process and the instruction that caused the change.

On a case start, the BG writes an entry to a predict lock database table if the workflow process is flagged for prediction. This entry matches a single row that is added by the BG process to a case information table.

Predict Queue(s)

In one embodiment, this queue is used to hold messages that are generated as part of the processing by the BG of instructions, which cause changes to cases.

The message that is en-queued contains the following information:

Case number

This number is the case number for which data/status has changed.

Reqid

This identifier is a unique request identifier, which is associated with steps sent out by the BG process.

Workflow process number

This number is the number of the workflow process associated with the case reference.

Instruction name

This name is the name of an instruction that was processed by the BG and caused a change in the case identified by case number above.

Update of Predication Data

When the BG process has posted a message with information about a changed case, a predict process reads the message from the predict queue(s) and updates the case database so that it contains the latest prediction information.

This predict process, much like the BG process, can have a number of instances running, to which more instances can be added (or removed).

With reference to FIG. 1, this predict process, for each instruction, calls the application layer 120 interface in order to generate an in-memory list of prediction steps that result from the change(s) made by the BG process. The predict process then flushes the cached prediction steps to the database so that they can be queried by external applications.

In one embodiment, the process of dequeuing a message from the predict queues, generating the prediction steps and updating the database all occurs as part of a transaction. If a step should fail then the transaction is rolled back and the message put back on the queue for processing at a later time.

In order to ensure that two processes are not updating the same workflow process and case number at the same time, a lock on the case-reference entry (workflow process & case number) is achieved. This lock holds until the processing has been completed and the transaction has been completed.

Database Tables

In one embodiment, two database tables store prediction data for cases.

Predict Lock

This table holds entries for each workflow process and case number that currently has predictions in a predict table. This table is used for locking a case reference while a predict process is processing it.

This table has the following format:

| Name | Type | Description |
|---|---|---|
| proc_num | Numeric | Workflow process number |
| case_num | Numeric | Case number |

Predict

This table holds prediction data for a given workflow process and case number. There exists a matching row in the predict lock table. This table can contain multiple rows for a single workflow process and case number, each row indicating the predicted step and any associated filed data.

This table has the following format:

| Name | Type | Description |
|---|---|---|
| proc_num | Numeric | Workflow process number |
| case_num | Numeric | Case number |
| step_name | String | Step name |
| step_desc | String | Step description |
| step_desc2 | String | Step description |
| step_addr | String | Step addressee |
| step_durn_secs | Numeric | How long the expected time is |
| | | between the step being active and |
| | | released. (seconds) |
| step_durn_usecs | Numeric | How long the expected time is |
| | | between the step being active and |
| | | released. (microseconds) |
| step_start | Date/time | When the step is expected to arrive on |
| | | a queue. |
| step_start_usecs | Numeric | Microseconds part of the step_start |
| | | column. |
| step_end | Date/time | When the step is expected to be |
| | | released. |
| step_end_usecs | Numeric | Microseconds part of the step_end |
| | | column. |
| field_name | String | field name |
| field_value | String | field value |

This table has a unique, primary key on the proc_num, case_num and field_name columns and a foreign key to the predict lock table on the proc_num and case_num columns.

According to one embodiment, when the workflow management system calls the prediction module 140, the workflow management system passes the following information to the prediction module 140:

1. the name of a workflow process to call

2. the case reference number (if the data for the case needs to be extracted by the prediction module 140 for an active case)

3. the step or steps to start processing from

4. an array of fields and values—that has been taken from an existing case when predicting on live cases or manually derived for simulation. This data will be used when evaluating conditions.

In another embodiment, the prediction module 140 requires a subset of this information, i.e., items 1 and 2, if predicting from a live case. With a live case, the system retrieves the process definition of the process specified and locates all the outstanding steps for the case using the case reference number. The system also retrieves the live case data for the process. The system retrieves the definition of these outstanding steps from the process and places a reference to the definition on an Outstanding Step List (OSL). The OSL is a list of steps waiting to be executed. The system then loops through the steps on the OSL executing them.

When the system executes a step, the system runs any initial and release scripts and calculates the step's expected end time (EET) from the individual step duration (SD). In computer programming, a script is a program or sequence of instructions that is interpreted or carried out by another program rather than by the computer processor (as a compiled program is). An initial Script is a script that an application calls when the user/application initially opens a work item from the work queue. The Release script is a script that an application calls when the user/application has completed the work item but prior to the workflow services being notified of the completion/release.

The SD is the time set at design time as the expected time the step will take to process from arriving on a queue to being released from the queue. The EET is the date and time in the future when the system expects that the workflow management system will release the step. The system evaluates actions on the step and may place more steps on the OSL as a result. When the execution of the step is complete, the system saves key information about the step, such as start time and expected end time, in a data store.

The prediction of the case includes the processing of deadlines and withdrawal actions where appropriate.

The prediction module 140 provides a query interface to access the data store and allow retrieval of the data about the future Work Items. In one embodiment, this interface provides a sort capability.

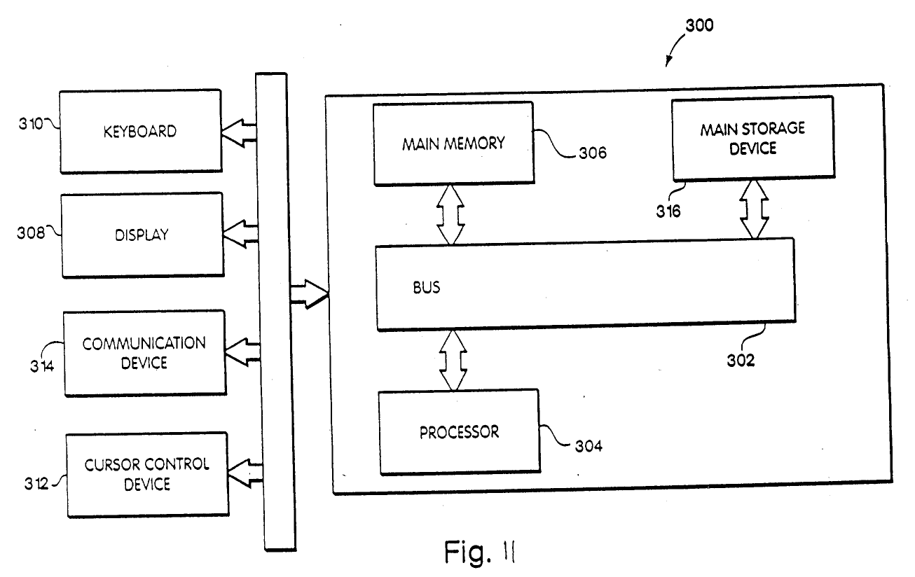

With reference to FIGS. 1 and 11, a system 300 representing an exemplary client 104, 102 or server 100 that can implement features of the present invention includes a bus or other communication means 302 for communicating information between components of the system. The system 300 further includes a processor 304 coupled to the bus 302 and a main memory, e.g., a random access memory (RAM) or other dynamic storage device 306 also coupled to the bus. The RAM stores instructions for execution by the processor 304. The main memory can also store temporary variables. The system 300 can include a mass storage device 316 coupled to the bus 302 for storing information that is not accessed as regularly as information stored in RAM.

System 300 can include a display 308 for displaying information such as a work list to a user. The system can include an input devices such as a cursor control device 312 and a keyboard 310 for allowing a user to input decisions. The impact of the decisions can include a display of a work list or lists.

The system 300 can also include a communication device 314. If the system 300 is implementing one portion of one embodiment of the invention, then the communication device 314 allows the system to communicate with other portions of the system and with the client 56. Alternatively, if the system 300 is implementing the system on a user's personal computer or personal digital assistant, the communication device 314 can include a network card, an RF transceiver, or other well-known communication device for coupling to a network.

Prediction Module 140

The following describes how an embodiment of the prediction module 140 can be set-up within the Process Definer (PD), how it can be called, what happens when it is called, how to access its results and how it is maintained.

There is a server setting and there are dialogue boxes within the PD to configure the Prediction module 140.

The prediction module 140 can be called:

1. When a trigger is issued because the background has performed an activity affecting a case e.g. a Work Item has been dispatched to a queue; a case has been started;

2. When a process object (PO) 104 makes a direct call to the prediction module;

When it has been called, the prediction module 140 uses the information it has been given to predict the date and time when future steps will be processed. In one embodiment, the prediction module 140 stores this information in a data store if started via option 1 or a list if started by option 2 above.

The results are available:

1. From a query interface if the results are from the background process

2. From a list if a Direct call has been made

There are two maintenance activities that affect the data store:

1. Loading the data store when restore and case restart occurs. A case can be closed (externally) before it has come to its natural conclusion. In this example, one embodiment of a system according to the invention can resurrect and restart the case. Similarly, the system can back up all the information that relates to a case and purge the online version of the case from the system. At some later date, the system can restore the information for a case from a previous backup and hence resurrect the case if required.

2. Deleting data from the data store when a case is closed or purged

Setting up to Use the Prediction Function

Set-up is split into two parts:

1. Server set-up

2. Process set-up

In one embodiment, this set-up requirement only applies to the Prediction function working as a background process.

Server Set-up

In one embodiment, there is a server setting that enables or disables Prediction. This setting provides users with the choice of whether or not they wish to use this functionality. In this embodiment, there is also a MAXLOOPS variable that limits the number of loops that can be tolerated on the server. This is configurable, but defaults to a high value.

According to one embodiment, there is also a MAXSUBPROCESSDEPTH variable, which prevents the sub-process calls descending beyond a pre-set limit. Use of this variable can help in situations where sub-processes are called recursively (possibly erroneously). In keeping with MAXLOOPS, MAXSUBPROCESSDEPTH is configurable but defaults to a large value (e.g., 100).

In one embodiment, each server representing one node can have its own setting.

1. Loading the data store when restore and case restart occurs. A case can be closed (externally) before it has come to its natural conclusion. In this example, one embodiment of a system according to the invention can resurrect and restart the case. Similarly, the system can back up all the information that relates to a case and purge the online version of the case from the system. At some later date, the system can restore the information for a case from a previous backup and hence resurrect the case if required.

2. Deleting data from the data store when a case is closed or purged

Setting up to Use the Prediction Function

Set-up is split into two parts:

1. Server set-up

2. Process set-up

In one embodiment, this set-up requirement only applies to the Prediction function working as a background process.

Server Set-up

In one embodiment, there is a server setting that enables or disables Prediction. This setting provides users with the choice of whether or not they wish to use this functionality. In this embodiment, there is also a MAXLOOPS variable that limits the number of loops that can be tolerated on the server. This is configurable, but defaults to a high value.

According to one embodiment, there is also a MAXSUBPROCESSDEPTH variable, which prevents the sub-process calls descending beyond a pre-set limit. Use of this variable can help in situations where sub-processes are called recursively (possibly erroneously). In keeping with MAXLOOPS, MAXSUBPROCESSDEPTH is configurable but defaults to a large value (e.g., 100).

In one embodiment, each server representing one node can have its own setting.

Process Set-up

In one embodiment, there are several additions to the PD to enable the prediction functionality. These additions affect the Process status, Work Steps and Conditions.

Process Status

With reference to FIG. 5, in one embodiment there is an additional flag in the Process status dialogue that enables or disables Prediction for the process. This flag gives users the flexibility of having processes with and without Prediction running on the same server.

In one embodiment, a sub-process has a Prediction flag to indicate whether or not it should be included in Prediction.

The Duration button provides a dialogue box where one can enter the duration period. In one embodiment, if one has entered the duration in the Sub-process status as above this cannot be overridden by the setting on the Sub-process step.

Process Work Steps

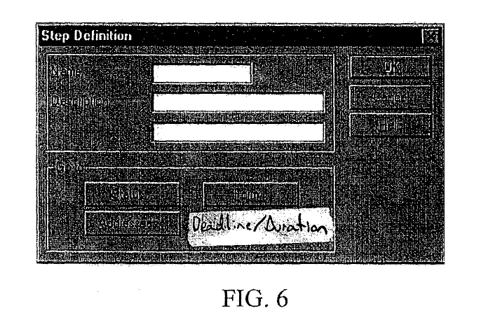

With reference to FIG. 6, each Work Step has a new dialogue box into which one can add the step duration. One can access this dialogue box from the Deadline/Duration button.

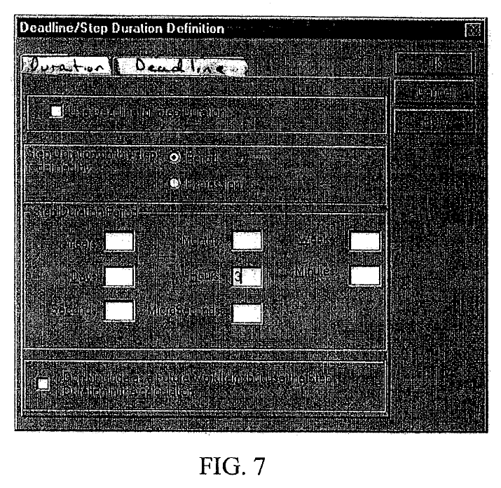

With reference to FIG. 7, the Deadline/Step Duration Definition dialogue box includes Step Duration and Deadlines tabs. The Step Duration and the deadline times can be entered independently by clicking on the Step Duration and Deadline tabs, respectively.

A checkbox allows the Prediction calculation to use the step duration, but excludes the Future Work Item from the output. This checkbox is useful for allowing the output to contain only Work Items to be processed manually excluding “Broker type” steps and Enterprise Application Integration (EAI) steps, i.e., non-manual steps.

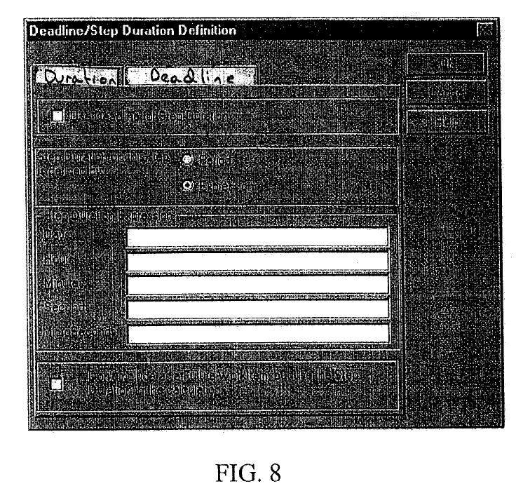

With reference to FIG. 8, one can enter the Step Duration using an expression.

In one embodiment, if one enters the deadline and the Step Duration needs to be the same then a check box indicates that the Deadline date and time determine the duration.

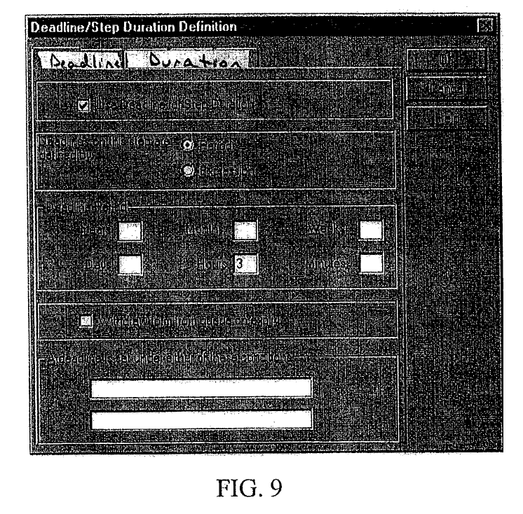

With reference to FIG. 9, when the user selects the “Duration tab”, and also selects the “Use deadline for Step Duration”, the duration tab of the form/dialogue box shows the deadline expression or period settings disabled so the user will be able to see what the deadline specifications are, but those deadline specifications can only be edited from the Deadline tab.

Process Conditional Actions

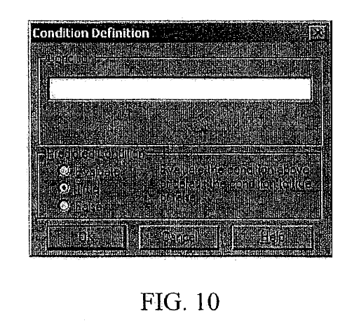

With reference to FIG. 10, the conditional action functionality extends to allow the inclusion of a predicted condition. One can select whether to evaluate the predicted condition or default the predicted condition to True or False.

If one selects “Evaluate,” the Prediction module 140 evaluates the condition to determine the route to take from the condition. Similarly, if one selects True or False, the Prediction module 140 defaults the condition to true or false, respectively, to determine the route to take from the condition.

Calling Prediction

A trigger initiated from the background can call prediction. The background can initiate a trigger when the background performs an activity affecting a case, e.g., when the background dispatches work to a queue or starts a new case. Alternatively, a PO can call the Prediction module 140 directly. These methods work independently of one another.

If the Prediction module 140 takes a copy of case data to use in a conditional calculation or in a script, the system stores the results back in the copy of the case data and does not impact the live case data.

From the Background Generating a Trigger

When the background performs an activity affecting a case it also triggers the Prediction module 140 if the Work Item belongs to a process with Prediction enabled. The background passes the Case Reference to the Prediction module 140 and the Prediction module 140 uses the case reference to locate all the outstanding steps for the case and retrieve the case data. With all the information it needs the Prediction module 140 then runs through the process and generates the future Work Items and associated data for output.

This method means that the future Work Items generated by the Prediction module are up to date and available for interrogation.

Directly From PO

A PO call from a Case Object passes in a case reference of a live case as an argument. (Optionally a list of steps and an array of data items can also be passed if Prediction is being used for simulation) Prediction then locates the process definition and case data and generates the future Work Items and associated data for output.

This method generates the future Work Items for Prediction on request.

How Prediction Generates Future Work Items

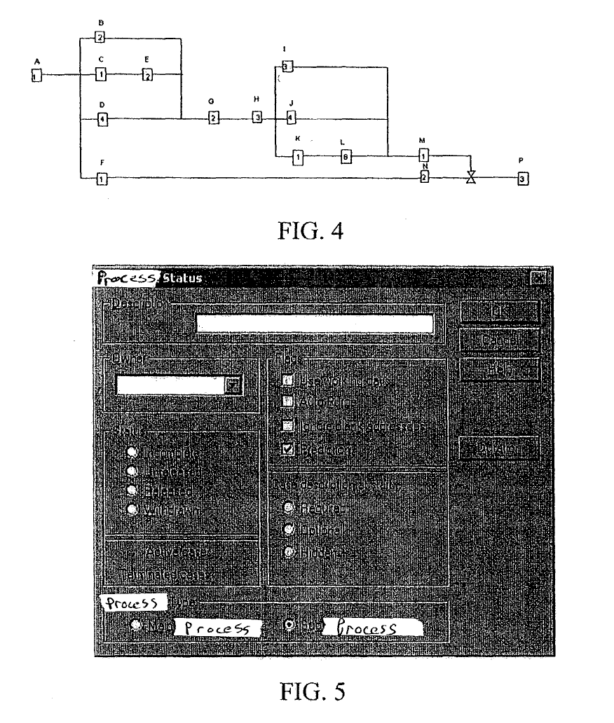

FIG. 4 provides an example process. The following provides information about how the prediction module handles different step types and sub-processes and uses the default condition.

Example Calculation

The example process detailed in FIG. 4 shows logic and data used by the prediction module (PM). The PM places steps waiting to be processed on the outstanding step list (OSL). When the PM processes a step, it places the step in a data store.

FIG. 4 shows a number of steps, i.e., steps A-N and P, each with a step duration (SD) defined, e.g., 1, 2, 3, or 4 hours, as shown in a box directly below the step label. For ease of calculation FIG. 4 uses a single unit of time, e.g., an hour. In other words, the numbers in the boxes are the duration of the step with which they are associated. In the illustrated example, the numbers in the boxes represent the duration of the associated step in hours. The steps are connected by lines that define paths that the process can follow.

More specifically, step A having a duration of 1 hour connects via parallel paths to steps B, C, D, and F having durations of 2, 1, 4, and 1 hours, respectively. Step C connects to step E having a duration of 2 hours. Steps B, E, and D each connect to step G having a duration of 2 hours, which in turn connects to step H having a duration of 3 hours. Step H connects via parallel paths to steps I, J, and K having durations of 3, 4 and 1 hours, respectively. Step K connects to step L having a duration of 8 hours. Steps I, J, and L each connect to step M having a duration of 1 hour. Step M connects to a wait construct described above. Step F connects to step N having a duration of 2 hours. Step N connects to the same wait construct to which step M is connected. Finally, the wait construct connects to step P having a duration of 3 hours. The logic below shows how the PM adds up each of the step durations so that the PM can calculate the expected end time (EET) for each step in the process.

When the PM places a new step on the OSL, the PM inserts the new step in the order of execution. The PM determines the order of execution according to the following rules.

If there are no steps in the OSL, the PM adds the step to the OSL. If there is one step in the OSL, the PM adds the step to the end of the OSL, as the PM is in the process of executing the first step. If there are two or more steps in the list, the PM starts at the second step and moves through the list examining each step in turn.

As the PM moves through the list, it compares the start time for the step being inserted with the step in the OSL being examined. If the start time for the step being inserted is greater than the selected/examined OSL step, then the PM moves to the next step in the OSL. If the selected/examined OSL step is the last step in the list, the PM adds the step being inserted to the end of the list. If the start time for the step being inserted is less than the selected/examined OSL step, the PM adds the step being inserted before the selected/examined OSL step.

If the start time for the step being inserted equals the OSL step, then the PM compares the end time for the step to be inserted with the selected/examined OSL step. If the end time for the step to be inserted is greater than the selected/examined OSL step, then the PM moves to the next item in the OSL. If the selected/examined OSL step is the last step in the list, then the PM adds the step to be inserted to the end of the list. If the end time for the step to be inserted is less than the selected/examined OSL step, then the PM inserts the step before the selected/examined OSL step. If the end time for the step to be inserted equals the selected/examined OSL step, then the PM adds the step to be inserted after the selected/examined OSL step.

Steps that the system has already executed remain in their current order when the PM adds new steps. These may be steps that precede WAITS that the system has executed, but cannot be removed because progress beyond the WAIT is dependent on other steps being executed first.

Duplicate steps may be removed if the start time of the duplicate step, i.e., a second instance of a step, to be added occurs in the time frame between the start and end time of the first instance of the step, the first instance already residing on the OSL.

As noted above, the execution order is the order the OSL.

When a system according to one embodiment of the invention processes a case for the process of FIG. 4, the PM places step A on the OSL and prediction calculates all of the future Work Items according to the rules just outlined. FIG. 4 shows steps A-N and P and includes several parallel paths and a wait construct.

In the example shown in FIG. 4, assuming step A started at 9 am, upon completion of the process described above, the resulting executed step list holds the following (the calculations that produce the following executed step list, which are not provided, are a straightforward application of the process described above to the example shown in FIG. 4): being inserted is less than the selected/examined OSL step, the PM adds the step being inserted before the selected/examined OSL step.

If the start time for the step being inserted equals the OSL step, then the PM compares the end time for the step to be inserted with the selected/examined OSL step. If the end time for the step to be inserted is greater than the selected/examined OSL step, then the PM moves to the next item in the OSL. If the selected/examined OSL step is the last step in the list, then the PM adds the step to be inserted to the end of the list. If the end time for the step to be inserted is less than the selected/examined OSL step, then the PM inserts the step before the selected/examined OSL step. If the end time for the step to be inserted equals the selected/examined OSL step, then the PM adds the step to be inserted after the selected/examined OSL step.

Steps that the system has already executed remain in their current order when the PM adds new steps. These may be steps that precede WAITS that the system has executed, but cannot be removed because progress beyond the WAIT is dependent on other steps being executed first.

Duplicate steps may be removed if the start time of the duplicate step, i.e., a second instance of a step, to be added occurs in the time frame between the start and end time of the first instance of the step, the first instance already residing on the OSL.

As noted above, the execution order is the order the OSL.

When a system according to one embodiment of the invention processes a case for the process of FIG. 4, the PM places step A on the OSL and prediction calculates all of the future Work Items according to the rules just outlined. FIG. 4 shows steps A-N and P and includes several parallel paths and a wait construct.

In the example shown in FIG. 4, assuming step A started at 9 am, upon completion of the process described above, the resulting executed step list holds the following (the calculations that produce the following executed step list, which are not provided, are a straightforward application of the process described above to the example shown in FIG. 4):

| Step Name | Start Time | Expected End Time |
|---|---|---|
| A | 9 | 10 |
| C | 10 | 11 |
| F | 10 | 11 |
| B | 10 | 12 |
| D | 10 | 14 |
| E | 11 | 13 |
| G | 12 | 14 |
| H | 14 | 17 |
| K | 17 | 18 |
| I | 17 | 20 |
| J | 17 | 21 |
| L | 18 | 24 |
| M | 20 | 21 |
| N | 11 | 13 |
| P | 21 | 24 |

Using the Default Route Condition

With reference to FIGS. 2 and 10, radio buttons in the conditional action box provide a user with three options with regard to how the prediction module decides which route to take after the condition:

1. Evaluate

2. True

3. False

Selecting the Evaluate radio button instructs the prediction module 140 to evaluate the condition to determine the route. If the default condition is true then this is the route taken and likewise if the default condition is false. If the user selects the evaluate option, the user also supplies a condition expression in the expression field in the conditional action box of FIG. 10. The condition expression can be a Boolean expression referencing data fields defined for the process. More specifically, at the time of defining steps, a designer can define data field for a process, which a condition expression can then reference.

More generally, when the prediction module is called for a case, it collects the most up to date case data at that time. This case data is then used for subsequent condition calculations. A conditional action, that has a true or false outcome, has a condition box to contain the condition to be evaluated and three definition options concerning prediction: Evaluate, True or False. One option must be chosen by the process developer to indicate to Prediction how it should deal with the condition. If Evaluate has been chosen Prediction will use its case data to evaluate the condition in the condition box and the true or false outcome will dictate which route it takes. If True or False is set the condition will be ignored and Prediction will take the True or False route respectively.

There are no guarantees in which order paths are predicted and therefore what the predicted field values will be if they are changed along more than one parallel path.

Modelling Cases

According to embodiments of the invention, one can use the prediction module 140 for modelling cases. One can specify a percentage probability of taking a particular route. Combined with the expected processing time for a step, the system can use the percentage probabilities for individual routes for calculating the percentage probability and the expected time taken for each total route through a process.

How Different Step Types are Handled in One Embodiment

In one embodiment, the prediction module processes the following step types:

Standard Work Step

Event

Sub Process

Enterprise Application Integration (EAI) Step

The prediction module follows sub-process routes returning to the main process as dictated by the Process Definer map.

The following is a description of how one embodiment of a system according to the invention manages each step type when it executes the step:

The system runs a Standard Work Step's initial and release scripts and reads the Step Duration and calculates the start time and end time for the step.

One can include an Event Step in a process for different reasons:

1. To pause a case for a pre-defined time using the deadline feature of the Event step

2. To suspend a case in expectation of an external Event trigger re-starting the step

3. To start a branch of a process independent of the main branch

4. To have a stand alone Event to allow ad-hoc addition of case data to a case

When the Prediction module finds an Event like Item 1 the deadline action processing determines what steps are to be placed on the OSL. In this instance the SD follows the deadline date and time.

The EET derived from an Event Step of the type outlined in Item 2 in a simulation depends on the simulated time of the relevant external event.

Items 3 and 4 are unknown to the Prediction module, as the Prediction module does not place the Event steps and subsequent steps, in the case of item 3, on the OSL. In an actual, i.e., not simulated, case, the system activates these steps via an external interface.

The system reads the SD of an EAI step and calculates the EET up to and including the step.

In one embodiment, if the system predicts the steps for a sub-process then the system will not include the sub-process step itself in the output as a future Work Item.

However, if the system is not predicting the sub-process step then the system includes the sub-process step as a future Work Item.

Retrieving Results

In embodiments of the invention there is a query interface to retrieve the results back from the data store and this populates a list within PO. This list allows the system to return the results in blocks, but in one embodiment there is no direct sorting and filtering on the list. The system can provide a sort facility with the query that generated the list. A direct call automatically populates a List.

The results returned by the PO interface contain future Work Items. Each Item in the lists described above can contain the following information:

| Field Name | Description |
|---|---|
| STEPNAME | Short step name |
| STEPDESC | Long step description |
| STEPDESC2 | Step attribute for further description |
| STEPDURN | Expected processing time of step |
| Dependent on Process | Zero or more parameters of Workflow Relevant |
| | Data (data field) that can be used as the subject of |
| | a query or sort operation |
| CASEREF | Unique case reference |
| ADDRESSEE | Addressee of the step/worker assigned to the step |
| ARRIVALDATE | The date when Prediction has calculated the step |
| | will arrive in a queue |
| ARRIVALTIME | The time when Prediction has calculated the step |
| | will arrive in a queue |
| LEAVEDATE | The date when Prediction has calculated the step |
| | will leave the queue |
| LEAVETIME | The time when Prediction has calculated the step |
| | will leave the queue |

Each data field can have a Prediction attribute that defaults to FALSE. If the Prediction attribute is set to TRUE for one or more Data Fields and those Data Fields are also associated with the Work Queue for a given addressee (worker) then, whenever a future work item includes that addressee, the information for the future work item will include those Data Fields.

In one embodiment, all of the above fields can be used in the query in conjunction with:

The comparison operator ‘=’.

The logical operator ‘AND’.

Use of wildcard characters ‘*’ and ‘?’ as part of equality checks.

Use of the additional operators ‘>=’, ‘<=’, ‘?’, and ‘<>’.

The logical operator ‘OR’.

Use of the regular expression operator ‘?’ between operands.

An example query is the following:

a) Find all future tasks for patient with ID 106783 that need to be completed in the next 8 hours

Assuming patient id is stored in a Data Field called PATIENT_ID. The limit of the date and time of interest can be calculated by adding 8 hours to the current date and time, incrementing the date if necessary. If the system stores the result of this calculation in ENDDATE and ENDTIME the query is the following:

PATIENT_ID=“106783” and LEAVEDATE <=ENDDATE and LEAVETIME <=ENDTIME

Loading the Data Store

In embodiments of the invention there are three levels of granularity available in the load function.

1. Predict all cases for all processes with Prediction enabled

2. Predict all cases for defined process if Prediction enabled

3. Predict a single case for a process if Prediction enabled for the process

If an administrator requests a system restore then the preload function loops through all of the processes on the server and checks if a process definer has enabled a prediction flag for the process. When a system is brought up and the system engages the prediction module then there is no prediction data generated for existing cases. Only when work items get released or new cases are started is prediction data generated. Therefore, in one embodiment, the system uses the preload facility on system start up to generate prediction data for all existing cases. When the system starts up it determines what cases are in existence and for each one causes a prediction to occur. If the process definer has enabled the prediction flag, then the preload function loops through all of the active cases for the process and predicts all of the future Work Items for each case loading the results into the data store. If a requestor requests a process restore then the preload function predicts just the cases of the process concerned. In the case of restarting a closed case the preload function preloads a single case.

Embodiments of the invention determine the expected outcome of an actual or imaginary case, by allowing a user to:

Predict the process path and duration of an active case by forecasting the outcome of outstanding steps using live case data.

Predict the outcome of outstanding steps for all active cases across all workflow processes that have prediction enabled

Simulate the processing of an imagined case with a specific set of start steps and test data.

Those skilled in the art will recognize numerous modifications to the present invention, and all such modifications are deemed within the scope of the present invention, only as limited by the claims.

What is claimed is:

1. A method for predicting a work list associated with a workflow process, the method comprising:
(a) receiving information regarding a workflow process;
(b) receiving a process definition for the workflow process;
(c) based on the process definition, determining at least one outstanding step for a case of the workflow process;
(d) receiving a definition for the outstanding step;
(e) executing the outstanding step to calculate an expected end time for the outstanding step;
using steps (a) to (e), predicting a work list of items that are expected to become due in association with the workflow process; and
(f) providing items from the work list according to a parameter of interest.

2. The method of claim 1, wherein the process definition for the workflow process includes a predicted condition.

3. The method of claim 2, wherein executing the outstanding step comprises:
executing the predicted condition based at least in part on the process definition and on case data.

4. The method of claim 1, wherein the parameter of interest includes a time interval of interest.

5. The method of claim 1, wherein the parameter of interest includes the case number of at least one workflow.

6. The method of claim 1, wherein the parameter of interest includes a worker of interest.

7. The method of claim 1, wherein the information regarding the workflow process includes a name of a workflow process and a case reference number associated with the workflow process.

8. A work list prediction system for predicting a work list for at least one specified process, the system comprising:
a process definition receiving module operative to receive a process definition for a specified workflow process;
a step determining module coupled to the process definition receiving module, the step determining module operative to determine at least one outstanding step for a case based on the process definition;
a step definition receiving module coupled to the step determining module, the step definition receiving module operative to receive a definition for the outstanding step; and
an execution module coupled to the step definition receiving module, the execution module operative to execute the outstanding step to calculate an expected end time for the outstanding step.

9. The system of claim 8, wherein the system further comprises:
A prediction information receiving module coupled to the process definition receiving module, the prediction information receiving module operative to receive information relating to a workflow of interest.

10. A method for predicting a work list, the method comprising:
(a) receiving information regarding a workflow process;
(b) receiving a process definition for the workflow process;
(c) based on the process definition, determining at least one outstanding step for a case;
(d) receiving a definition for the outstanding step; and
(e) executing the outstanding step to calculate an expected end time for the outstanding step.

11. The method of claim 10, wherein the process definition for the workflow process includes a predicted condition.

12. The method of claim 11, wherein executing the outstanding step comprises:
executing the predicted condition based at least in part on the workflow process definition and on case data.

13. The method of claim 12 wherein executing the predicted condition comprises determining a setting of the condition definition.

14. The method of claim 10, wherein the method further comprises:
using steps (a) to (e) to predict work items that are expected to become due within a time interval of interest; and
providing items from the work list according to a parameter of interest.

15. The method of claim 14, wherein providing items from the work list comprises providing items from the work list in response to a query involving a parameter of interest.

16. The method of claim 10, wherein the information regarding the workflow process includes a time interval of interest.

17. The method of claim 10, wherein the information regarding the workflow process includes the case reference number associated with the workflow process.

18. The method of claim 10, wherein the information regarding the workflow includes a worker of interest.

19. The method of claim 10, wherein the information regarding the workflow process includes a name of the workflow process.

20. The method of claim 10, wherein the information regarding the workflow process includes case data.
